(19) United States
(12) Patent Application Publication
(10) Pub. No.: US 2015/0342239 A1
(43) Pub. Date: Dec. 3, 2015

(54) METHOD FOR SMOKING MEAT

(71) Applicant: HORMEL FOODS CORPORATION, Austin, MN (US)

(72) Inventor: Jeffrey Dean DIERENFELD, Spicer, MN (US)

(73) Assignee: HORMEL FOODS CORPORATION, Austin, MN (US)

(21) Appl. No.: 14/289,306

(22) Filed: May 28, 2014

(51) Int. Cl. A23L 1/314; A23L 1/00

(52) U.S. Cl. CPC A23L 1/31445; A23L 1/005; A23V 2002/00

(57) ABSTRACT

A method for smoking meat comprises applying a dry smoke powder to an exterior surface of a meat to create a treated meat, inserting the treated meat into a cooking bag, sealing the cooking bag to create a bagged meat, and cooking the bagged meat with steam to a desired internal temperature of the meat.

### BACKGROUND OF THE INVENTION

The present invention generally relates to a method for smoking meat that differs from traditional meat smoking processes in that it does not involve dry heat, which results in significant moisture loss in meat. Traditionally, smoking meat is a dry heat process where the surface of the meat is conditioned and then smoke is applied through atomization or by burning natural wood directly to the meat or through moisture penetrable casings resulting in cook yield loss of 15 to 30%. Smoking is desirable to enhance the flavor and the color of meat. Rather than utilizing a dry heat process, the present invention utilizes a high moisture cooking process for smoking meat, and the resulting cook yield loss is much less.

For the reasons stated above and for other reasons stated below, which will become apparent to those skilled in the art upon reading and understanding the present specification, there is a need in the art for an improved method of smoking meat.

### BRIEF SUMMARY OF THE INVENTION

The above-mentioned problems associated with prior devices are addressed by embodiments of the present invention and will be understood by reading and understanding the present specification. The following summary is made by way of example and not by way of limitation. It is merely provided to aid the reader in understanding some of the aspects of the invention.

In one embodiment, a method for smoking meat comprises applying a dry smoke powder to an exterior surface of a meat to create a treated meat, inserting the treated meat into a cooking bag, sealing the cooking bag to create a bagged meat, and cooking the bagged meat with steam to a desired internal temperature of the meat.

In one embodiment, a method for smoking a whole turkey comprises injecting a whole turkey with a solution, applying a dry smoke powder to a top exterior surface of the whole turkey to create a treated whole turkey, inserting the treated whole turkey into a cooking bag, sealing the cooking bag to create a bagged whole turkey, and cooking the bagged whole turkey with steam to a desired internal temperature of a breast meat portion of the whole turkey of at least 165° F. The whole turkey is injected with approximately 5.0 to 20.0 wt % of a solution based upon a weight of the whole turkey prior to injection. Approximately 0.01 to 0.10 wt % of dry smoke powder based upon the weight of the whole turkey prior to injection is applied to a top exterior surface of the whole turkey.

### BRIEF DESCRIPTION OF THE DRAWINGS

The present invention can be more easily understood, and further advantages and uses thereof can be more readily apparent, when considered in view of the detailed description and the following Figures in which:

FIG. 1 is a schematic embodiment method of meat smoking in accordance with the principles of the present invention;

FIG. 2 is an example cooking cycle for whole turkeys;

FIG. 3 is another example cooking cycle for whole turkeys;

FIG. 4 is an example cooking cycle for natural shape single turkey breast lobes;

FIG. 5 is an example cooking cycle for single turkey breasts; and

FIG. 6 is an example cooking cycle for deli style chicken breasts.

In accordance with common practice, the various described features are not drawn to scale but are drawn to emphasize specific features relevant to the present invention. Reference characters denote like elements throughout the Figures and the text.

### DETAILED DESCRIPTION OF THE INVENTION

In the following detailed description, reference is made to the accompanying drawings, which form a part hereof, and in which is shown by way of illustration embodiments in which the inventions may be practiced. These embodiments are described in sufficient detail to enable those skilled in the art to practice the invention, and it is to be understood that other embodiments may be utilized and mechanical changes may be made without departing from the spirit and scope of the present invention. The following detailed description is, therefore, not to be taken in a limiting sense, and the scope of the present invention is defined only by the claims and equivalents thereof.

Embodiments of the present invention provide methods for smoking meat. Meat could include any suitable type of meat, such as but not limited to, beef, pork, and poultry.

The term “treated meat” is being used herein to describe meat onto which a dry smoke powder or a mixture including a dry smoke powder and suitable seasoning(s) and/or flavoring(s) has been applied.

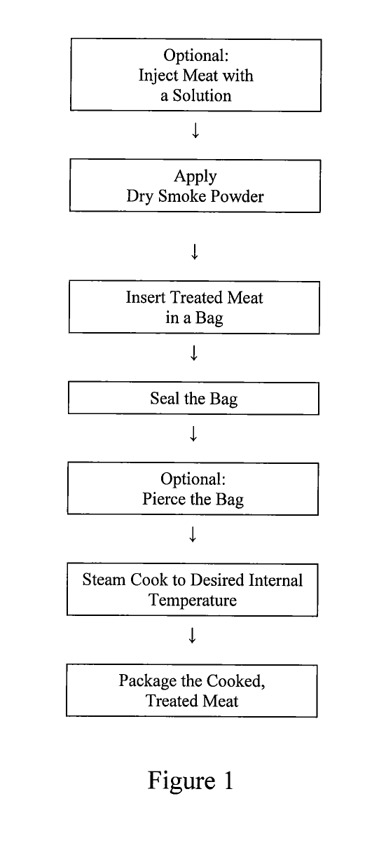

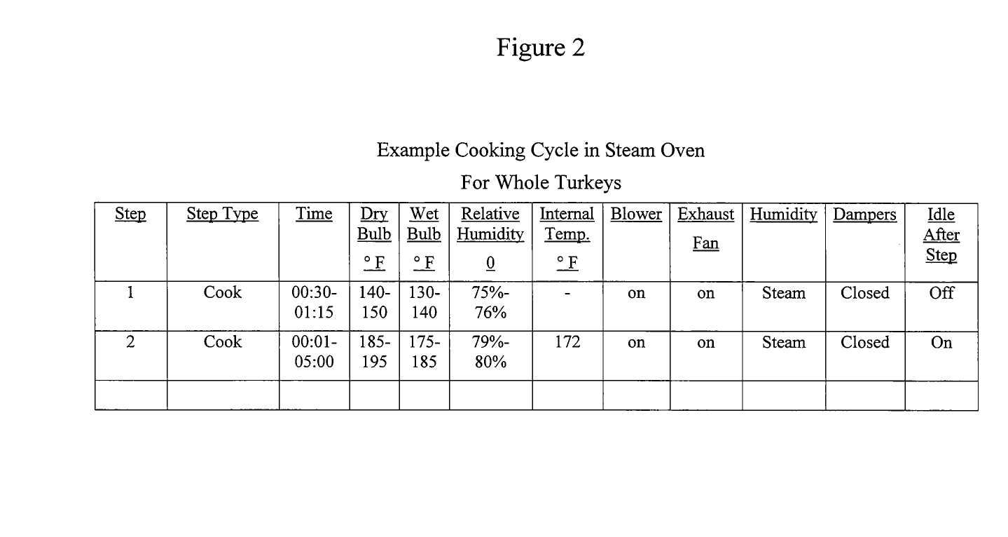

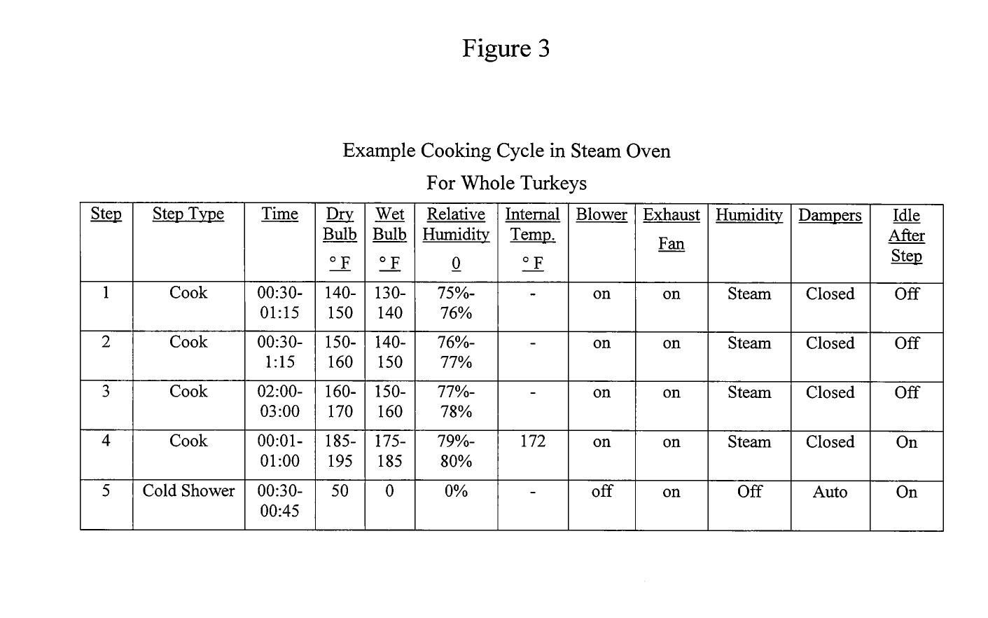

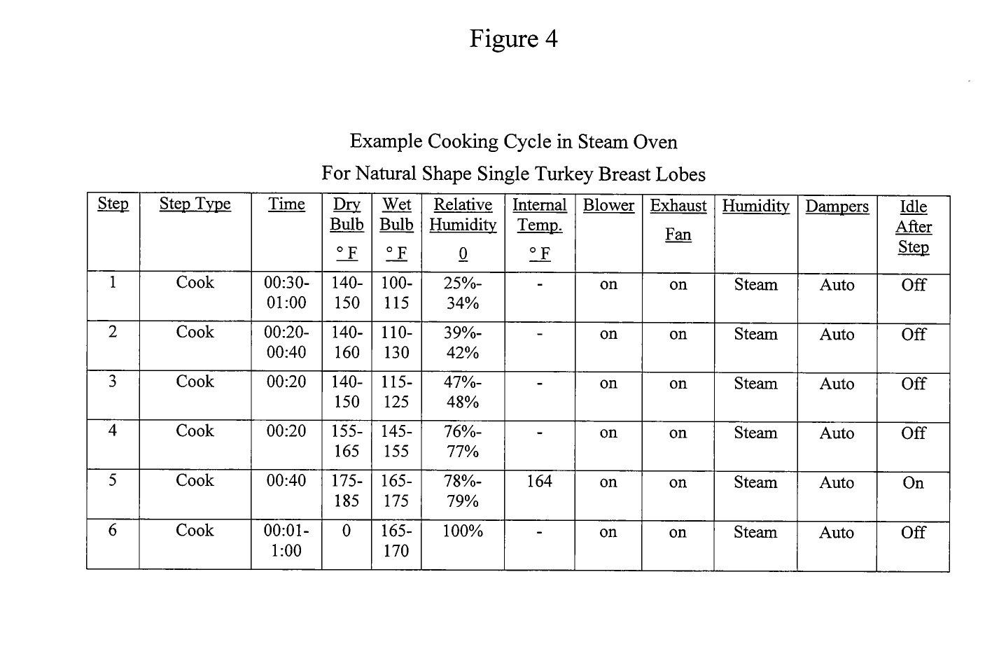

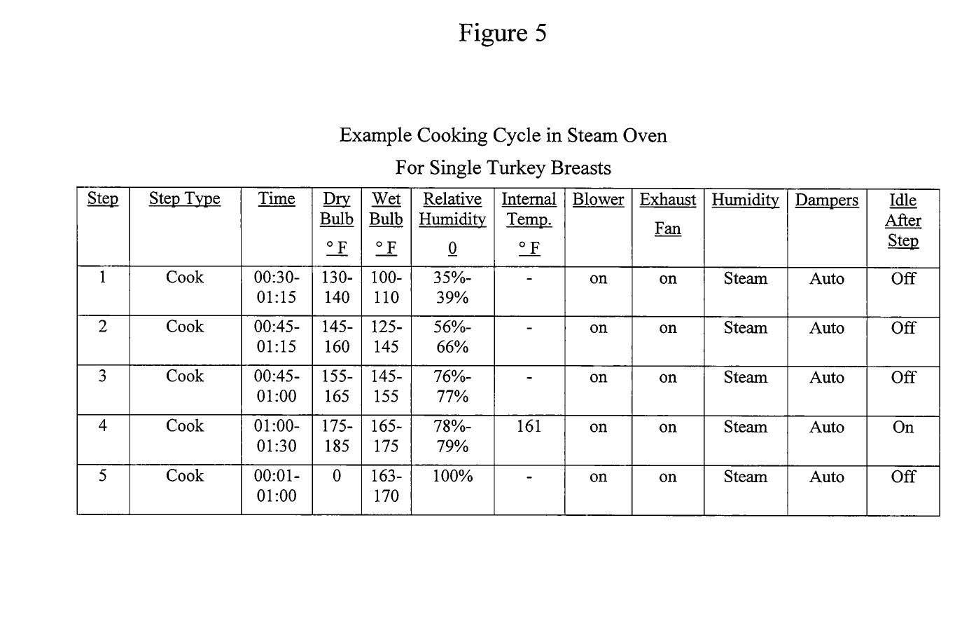

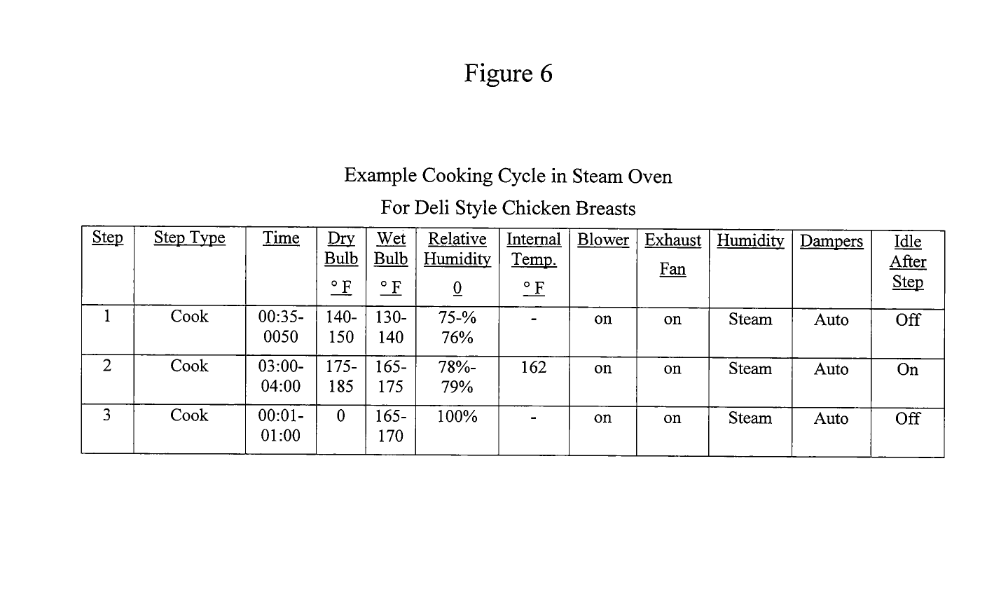

Generally, as shown in FIG. 1, meat could optionally be injected with a solution, such as but not limited to a brine solution, to approximately 5.0 to 20.0 wt % based upon the weight of the meat prior to injection. A dry smoke powder is applied to the exterior surface of the meat. It is recognized that the dry smoke powder could be part of a mixture including a variety of suitable seasonings, spices, and other suitable additives such as but not limited to salt, pepper, paprika, turmeric, annatto, cumin, herbs, rosemary extract, and blends thereof. Approximately 0.01 to 0.10 wt % of dry smoke powder, or a mixture including dry smoke powder, is applied to the meat based upon the weight of the meat prior to injection. It is recognized that the dry smoke powder or the mixture including dry smoke powder could be applied to the exterior surface of the meat where it is desired to have a smoke color in the meat. For example, the dry smoke powder or the mixture including dry smoke powder could be applied to just the top exterior surface of the meat or the exterior surface of the meat shown in a bird's eye view of the meat. During cooking, the dry smoke powder or the mixture including dry smoke powder will mix with steam and run down the sides to the bottom of the meat thereby applying the dry smoke powder or the mixture including dry smoke powder to the sides and the bottom of the meat. After application of the smoke powder or the mixture including smoke powder, the treated meat is inserted into a suitable cooking bag. The bag is sealed, and the bag is optionally pierced. The bagged meat is cooked in a steam oven to a desired internal temperature, which depends upon the type of meat. Although any suitable cooking cycle and parameters could be used, an example for whole turkeys is provided in FIGS. 2 and 3, an example for natural shape single turkey breast lobes is provided in FIG. 4, and example for single turkey breasts is provided in FIG. 5, and an example for deli style chicken breasts is provided in FIG. 6. FIG. 2 could be used with other types of meat but the internal temperature of the final cook step would be different because the meat should be cooked to the safe minimum internal temperature provided by the United Stated Department of Agriculture (USDA). In FIG. 3, the cold shower step is optional and may be used to speed up the cooling process of the meat. Preferably, in any suitable cooking cycle, the meat is cooked to the safe minimum internal temperature provided by the USDA. The cooked, treated meat is then packaged.

The cooked, treated meat could be packaged by cooling the bagged meat and then placing the bagged meat in another bag, a packaging bag. The packaged meat could then be frozen and distributed for sale. The consumer could defrost the meat, remove the meat from both bags, the packaging bag and the cooking bag, and heat the meat in an oven to a desired temperature. Because the meat is only heated, not cooked, in an oven, there is not a significant amount of moisture loss in the meat. The result is an evenly browned, moist meat with a light smoky flavor and color.

One type of meat that could be used with this method is a whole turkey. The turkey could be injected with a brine solution and then sprinkled with a mixture including a dry smoke powder and suitable seasoning(s) and/or flavoring(s). The treated turkey is placed in a moisture-proof bag and then sealed with a clip. The bag is preferably pierced or punctured proximate below at least one wing so that it does not balloon during steam cooking and so that water does not collect in the bag during an optional shower cooling step in the oven. The bagged turkey is steam cooked until the internal temperature of the breast meat is at least 165° F. The bagged turkey is allowed to cool and then it is placed in a second bag before it is frozen. The consumer defrosts the turkey, removes the turkey from the two bags, and heats the turkey, uncovered, in the oven. Because the turkey is only heated, not cooked, in an oven, there is not a significant amount of moisture loss in the turkey. The result is an evenly browned, moist turkey with a light smoky flavor and color.

The dry smoke powder permeates the meat during the steam cooking so that the entire product has the flavor and color of smoked meat, however, the result is smoked meat that is moister than traditionally smoked meat. The present invention allows for meat to be smoked using a steam cooking process rather than a dry cooking process. The meat is not just flavored but is smoked with the smoke flavoring thereby resulting in meat that has a smoked flavor and color. A benefit of the present invention is that there is not a reduced yield after cooking because the turkey is steam cooked, not dry heat cooked.

### EXAMPLE 1

A-Grade whole young turkeys were selected in a weight range from 9.1 to 11.1 pounds. The turkeys were mechanically injected with a solution including ingredients as shown in Table 1. The turkeys were injected with approximately 10% solution based on the weight of the turkey, resulting in approximately 110% weight after injection.

TABLE 1
Ingredients of Injection Solution

| Ingredient | Amount |
|---|---|
| Water | 5.0 to 10.0% |
| Salt | 0.5 to 2.0% |
| Dextrose | 0.5 to 2.0% |
| Phosphate | 0.25 to 0.5% |
| Carrageenan | 0.1 to 0.5% |
| Sodium Nitrite | less than 156 ppm nitrite based on |
| | meat weight prior to injection |

Following injection, the turkeys were placed breast side up on a stainless surface and dusted by hand with smoke powder, Smoke Powder 5320 CMO, Part Number 30589719, manufactured by Kerry Ingredients located in Beloit, Wisconsin. Approximately 0.05 to 0.10% smoke powder based on the weight of the turkey prior to injection was applied to a top exterior surface of each turkey. Any suitable smoke powder could be used including those containing various other suitable types of seasonings and/or flavorings.

Following smoke powder dusting, each of the turkeys was placed breast side up into a 18×27 inches cooking bag, Kenylon 3114 cooking bag manufactured by KNF Flexpak Corporation located in Tamaqua, Pa. The bags were gathered proximate the hocks of the turkeys and clipped shut with metal clips. Preferably, the cooking bag is punctured proximate below at least one wing so that water does not collect in the bag during a shower cooling step in the oven. Because the bag is punctured, it does not balloon away from the turkey during cooking. It is preferred that the bag not balloon away from the turkey to provide more consistent cooking and shorter cook times.

The bagged turkeys were then placed breast side up on stainless steel cooking racks, and the turkeys were cooked in an ALKAR steam cook batch oven, manufactured by ALKAR-RapidPak, Inc. of Lodi, Wis. Any suitable steam oven could be used. An example of a suitable cooking cycle is shown in FIG. 3. For this example, the minimum pull temperature is 168° F., and the average cook time is 6:00 hours. An optional shower cooling step occurs in the steam oven after cooking.

During cooking, a smoke vapor is created within the cooking bag. The smoke vapor mixes with the smoke powder, some of which drips down the sides of the turkey. This smokes the turkey meat, adding smoke flavor and color to the meat.

After cooking, the turkeys remained on the cooking racks and were held in a take down cooler, until Hazard Analysis and Critical Control Points (HACCP) cooling curve requirements were met.

For packaging of each turkey, a hole was punctured through the cooking bag, into the cavity of the turkey, and the turkey remained in the original cooking bag. The turkey in the cooking bag was then overbagged with a packaging bag. The vent hole was punctured into the cavity of the turkey so that a substantially complete vacuum could be drawn during packaging and substantially no air remained trapped inside the cavity of the turkey. The turkeys were then boxed and frozen.

Because the smoked turkey is preferably fully cooked, the consumer could thaw the turkey, remove the turkey from both bags (the packaging bag and the cooking bag), and heat the turkey. For example, the consumer could thaw the turkey for approximately 48 to 72 hours in a refrigerator or thaw the turkey for approximately 10 to 12 hours in cold water, changing the water hourly. Preferably, the turkey is kept in both bags until it has thawed. To heat the turkey, the consumer could preheat an oven to 300° F., remove the turkey from both bags, and place the turkey and any juices in a roasting pan, uncovered. The turkey could be heated in the oven for approximately 2 to 2.5 hours. After heating in the oven, the consumer could let the turkey stand for approximately 20 minutes before cutting. Any drippings could be used to make gravy.

Final smoke color development, to a desired golden brown color, of the turkey takes place in the consumer's oven, which is a dry oven, not a steam oven. The desired golden brown color could be defined by three sets of Minolta colorimeter L*a*b* values shown in Table 2.

TABLE 2
Minolta Colorimeter Values for a Desired Golden Brown Color

| | |
|---|---|
| Ideal Golden | L*48.67 |
| | a*19.56 |
| | b*41.53 |
| Dark Golden | L*28.52 |
| | a*19.37 |
| | b*13.50 |
| Light Golden | L*50.82 |
| | a*17.83 |
| | b*49.41 |

In other words, suitable Minolta colorimeter L*a*b* values for a desired golden brown color for turkey are L* 28.52 to 50.82, a* 17.83 to 19.56, and b* 13.50 to 49.41.

The above specification, examples, and data provide a complete description of the manufacture and use of the composition of embodiments of the invention. Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the invention. Therefore, it is manifestly intended that this invention be limited only by the claims and the equivalents thereof

1. A method for smoking meat, comprising:
applying a dry smoke powder to an exterior surface of a meat to create a treated meat;
inserting the treated meat into a cooking bag;
sealing the cooking bag to create a bagged meat; and
cooking the bagged meat with steam to a desired internal temperature of the meat.

2. The method of claim 1, wherein the dry smoke powder is part of a mixture further comprising at least one of salt, pepper, paprika, turmeric, annatto, cumin, herbs, and rosemary extract.

3. The method of claim 1, further comprising injecting the meat with a solution prior to applying seasoning.

4. The method of claim 3, wherein the meat is injected with approximately 5.0 to 20.0 wt % of the solution based upon the weight of the meat prior to injection.

5. The method of claim 1, wherein approximately 0.01 to 0.10 wt % of dry smoke powder based upon the weight of the meat prior to injection is applied to the exterior surface of the meat.

6. The method of claim 1, further comprising piercing the cooking bag prior to cooking the bagged meat with steam.

7. The method of claim 1, wherein the bagged meat is cooked for 0.50 to 6.25 hours at 140 to 195° F. dry bulb and 130 to 185° F. wet bulb.

8. The method of claim 7, wherein the meat is a whole turkey.

9. The method of claim 1, further comprising cooling the cooked, bagged meat using a shower in the steam oven.

10. The method of claim 1, further comprising cooling and packaging the cooked, bagged meat.

11. The method of claim 10, further comprising removing the meat from the packaging and the cooking bag and heating the meat in an oven to a desired temperature.

12. A method for smoking a whole turkey, comprising:
injecting a whole turkey with approximately 5.0 to 20.0 wt % of a solution based upon a weight of the whole turkey prior to injection;
applying approximately 0.01 to 0.10 wt % of dry smoke powder based upon the weight of the whole turkey prior to injection to a top exterior surface of the whole turkey to create a treated whole turkey;
inserting the treated whole turkey into a cooking bag;
sealing the cooking bag to create a bagged whole turkey; and
cooking the bagged whole turkey with steam to a desired internal temperature of a breast meat portion of the whole turkey of at least 165° F.

13. The method of claim 12, wherein the dry smoke powder is part of a mixture further comprising at least one of salt, pepper, paprika, turmeric, annatto, cumin, herbs, and rosemary extract.

14. The method of claim 12, further comprising piercing the cooking bag prior to cooking the bagged whole turkey with steam.

15. The method of claim 12, wherein the bagged whole turkey is cooked for 0.50 to 6.25 hours at 140 to 195° F. dry bulb and 130 to 185° F. wet bulb.

16. The method of claim 12, further comprising cooling and packaging the cooked, bagged whole turkey.

17. The method of claim 16, further comprising removing the whole turkey from the packaging and the cooking bag and heating the whole turkey in an oven to a desired temperature.

18. The method of claim 17, further comprising preheating the oven to 300° F., placing the whole turkey in the preheated oven for approximately 2 to 2.5 hours.
